(19) United States
(12) Patent Application Publication
(10) Pub. No.: US 2013/0124368 A1
(43) Pub. Date: May 16, 2013

(54) PERFORMING DEDUPLICATION ON PRODUCT INFORMATION SEARCH RESULTS

(71) Applicant: Alibaba Group Holding Limited, George Town (KY)

(72) Inventors: Linfeng Zhang, Hangzhou (CN); Jian Liao, Hangzhou (CN); Tianji Zhang, Hangzhou (CN); Weiwei Wang, Hangzhou (CN); Xiaoying Weng, Hangzhou (CN); Minjie Zhang, Hangzhou (CN)

(73) Assignee: ALIBABA GROUP HOLDING LIMITED, George Town (KY)

(21) Appl. No.: 13/672,336

(22) Filed: Nov. 8, 2012

(30) Foreign Application Priority Data
Nov. 11, 2011 (CN) 201110358156.3

(51) Int. Cl. G06Q 30/00

(52) U.S. Cl. 705/26.62

(57) ABSTRACT

Performing deduplication on product information search results is disclosed, including: receiving update information associated with stored product information; retrieving and updating the stored product information and sets of feature vectors associated with the stored product information, wherein updating includes generating sets of feature vectors for any newly added pieces of product information or modified pieces of product information determined based at least in part on the update information; determining correlations between pieces of the updated stored product information based at least in part on the updated sets of feature vectors; and classifying one or more pieces of the updated stored product information into a category based at least in part on the determined correlations associated with the one or more pieces of the updated stored product information, wherein in response to a subsequent search query, a piece of product information is to be selected from the category.

### CROSS REFERENCE TO OTHER APPLICATIONS

This application claims priority to People's Republic of China Patent Application No. 201110358156.3 entitled METHOD AND DEVICE FOR REAL-TIME DUPLICATION-DELETION OF PRODUCT INFORMATION filed Nov. 11, 2011 which is incorporated herein by reference for all purposes.

### FIELD OF THE INVENTION

The present application relates to the field of data processing. Specifically, it relates to techniques for deduplication of product information within search results.

### BACKGROUND OF THE INVENTION

Internet e-commerce is developing at an ever-growing rate. On many consumer-to-consumer (C2C) and business-to-consumer (B2C) e-commerce websites, seller users publish and update large volumes of product information (which is sometimes called “offer information”) every day. When buyer users search for the products they need, e-commerce websites display search results based on matching pieces of product information submitted by seller users. For example, when buyer users search for “mobile phones,” an e-commerce website will search within all seller-published product information for pieces of product information that include the terms “mobile phone.” Then the e-commerce website will display all the pieces of product information that include mobile phone information on the website so that buyer users can browse the matching product information.

However, a seller user may submit redundant product information. A seller user may submit multiple pieces of identical product information (e.g., product listings) for the product of a jade necklace so that the redundant product listings might be found for a buyer user's search for the keyword “necklace.” That way, the seller user's duplicate product listings may catch the buyer user's eye while the buyer user scans the returned product listings. However, buyer users may not desire to peruse through redundant product listings since they may feel that it is not helpful and also inefficient for finding desirable information.

Existing systems may attempt to determine duplicate product information on a periodic basis. Such techniques are mostly offline in the sense that the techniques periodically examine the product information that is currently stored and identifies the duplicate pieces.

FIG. 1 is an example of a process for determining duplicate product information that is used by some existing systems.

At 102, user submitted product information is stored at a server. For example, pieces of product information submitted by one or more seller users may be stored at the server in process 100.

At 104, periodically, offline feature vector computations are performed on the stored product information that is stored at the server and correlations between pieces of the product information are determined. For example, the period may be one month. So every month, the product information that is currently stored is analyzed, feature vector computations between different pieces of the product information are determined, and correlations between the different pieces of product information are determined.

At 106, deduplication is performed on the stored product information based on the determined correlations between the different pieces of product information. For example, two pieces of product information may be determined to be duplicates of each other based on their correlation to each other and so one of such pieces may be deleted from storage.

However, such an offline approach may fail to perform deduplication of product information in time for a buyer user's search that takes place after a duplicate piece of product information is added to storage. For example, Seller A may submit two copies of the same mobile phone product information on Monday. Because the next offline deduplication operation has not yet been executed (e.g., because the next deduplication operation is to be executed next Monday), both copies of the mobile phone information will still appear within search results if Buyer B searches for mobile phone product information before next Monday. As a result, the search results from the search engine will contain redundant information, including the two copies of the same mobile phone product information that were submitted by Seller A. Buyer B may be disadvantaged by having to spend time to determine that at least two of the search results are identical and is also denied an additional unique search result.

### BRIEF DESCRIPTION OF THE DRAWINGS

Various embodiments of the invention are disclosed in the following detailed description and the accompanying drawings.

FIG. 1 is an example of a process for determining duplicate product information that is used by at least some existing systems.

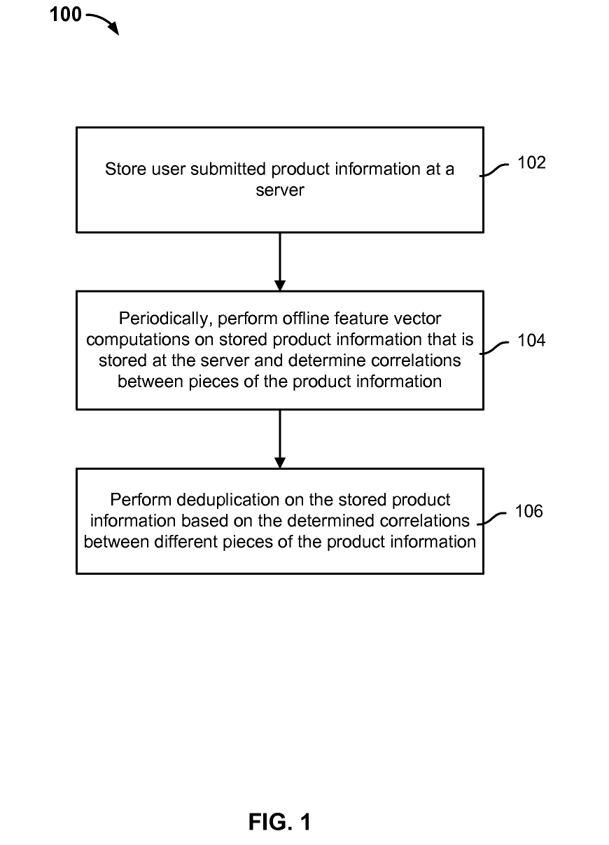

FIG. 2 is a diagram showing an embodiment of a system for performing deduplication on product information search results.

FIG. 3 is a flow diagram showing an embodiment of a process for performing deduplication of product information search results.

FIG. 4 is a diagram showing an embodiment of a system for performing deduplication on product information search results.

FIG. 5 is a diagram showing an embodiment of a system for performing deduplication on product information search results.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Before describing embodiments of the present application in greater detail, we will describe a suitable computer system architecture that can be used to implement the principles of the present application. In the descriptions below, embodiments of the present application are described with reference to the symbols for actions and operations executed by one or more computers, unless otherwise stated. It can thereby be understood that such actions and operations that are claimed to have been executed by one or more computers sometimes may include operations by computer processing units on electric signals expressed in structured form as data. These steps for converting data or of maintaining it in positions in a computer storage system involve reconfiguring or changing computer operations in a manner that can be understood by persons skilled in the art. The data structures for maintaining data are physical positions of the storage device with specific attributes defined by the data format. However, although the present application is described in the aforementioned context, such descriptions do not imply limitations. As understood by persons skilled in the art, every aspect of the actions and operations described below can also be achieved through hardware.

As to the figures, the same reference numbers therein indicate the same elements. The principles of the present application are shown as being implemented in a suitable computer environment. The descriptions below are based on said present application embodiments, and it should not be assumed that the present application is limited because alternative embodiments are not described herein.

The principles of the present application can be put into operation through other general or specialized computer or communication environments or configurations. Examples of universally known computer systems, environments, and configurations applicable to the present application include, but are not limited to, personal computers, servers, multi-processing systems, micro-processing-based systems, mini-computers, mainframe computers, and distributed computing environments that include any of the above systems or equipment.

In their most basic configuration, real-time duplication-deletion devices for product information can be located in servers. Servers can include but are not limited to processing devices such as microprocessor MCUs or programmable logic device FPGAs, storage devices for storing data, and transmission devices for communicating with clients.

The terms “sub-module,” “module,” “component,” or “unit” as used by the present application can refer to software objects or routines executed on hardware. The different components, sub-modules, modules, units, engines, and services described here may be realized as objects or processes (e.g., as an independent thread). Although the systems and processes described here are preferably realized through software, one may also conceive of realizing them through hardware or through combinations of hardware and software.

Deduplication of product information search results is described herein. In various embodiments, stored product information is deduplicated in real-time. In some embodiments, a set of existing product information is maintained. For example, the set of existing product information may include product information submitted by seller users. In some embodiments, an update to the stored product information is received. For example, an update may include user submitted new pieces of product information being added to the stored product information, modifications to existing pieces of stored product information, and/or deletion of any existing pieces of stored product information. In some embodiments, in response to the update to the product information, deduplication is performed on the updated set of product information (e.g., the set of stored existing product information modified by the received update). As a result, for a search query received subsequent to an update to the stored product information, the found search results will likely not include duplicate pieces of product information.

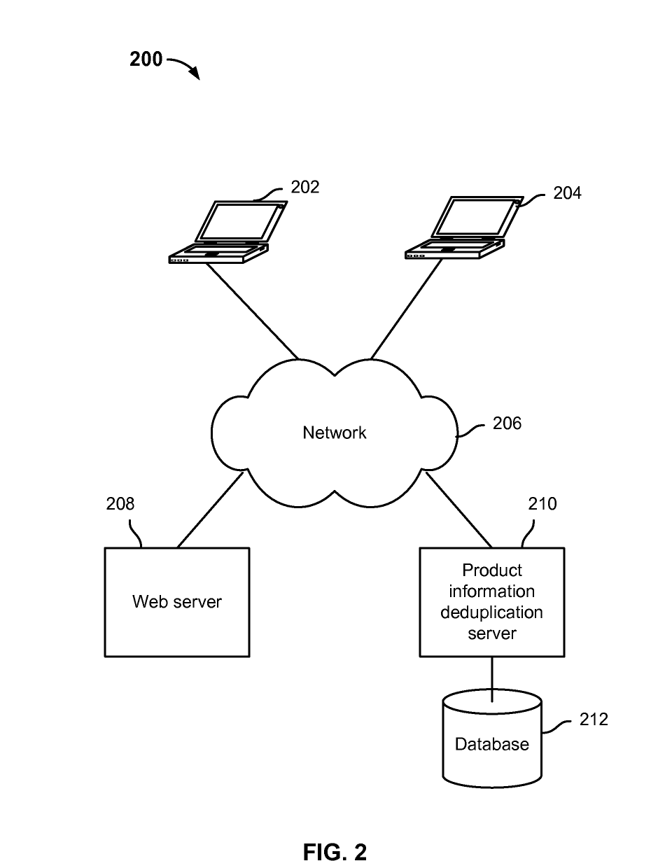

FIG. 2 is a diagram showing an embodiment of a system for performing deduplication on product information search results. In the example, system 200 includes client 202, client 204, network 206, web server 208, product information deduplication server 210, and database 212. Network 206 includes high-speed data networks and/or telecommunications networks.

Clients 202 and 204 may communicate with web server 208 over network 206 such as when a user using either client 202 or client 204 accesses a website supported by web server 208. In some embodiments, the website may be an e-commerce website. While clients 202 and 204 are each shown to be a laptop, other examples of clients 202 and 204 are desktop computers, mobile devices, smart phones, tablet devices, and any other type of computing device. For example, a seller user may submit product information associated with products that the user is selling at the website to web server 208. In some embodiments, web server 208 may send the submitted product information to product information deduplication server 210, which then stores the product information at database 212. Sometimes, a seller user may submit redundant pieces of product information to be displayed for users, thinking that the redundant information would increase the chances that a buyer user would purchase his products. However, buyer users may not desire to receive redundant product information within search results and so deduplication is needed to be performed on the product information stored at database 212.

A user (e.g., a seller) using client 202 may submit an update to the product information of the website to web server 208. The update may include adding new product information, modifying existing product information, and/or deleting existing product information from database 212. In response to receiving update information, web server 208 is configured to send a message to product information deduplication server 210, where the message includes the update information. The product information deduplication server 210 will update the product information stored at database 212 based on the received update information and perform deduplication on the updated product information. As will be further discussed below, in performing deduplication, product information deduplication server 210 classifies similar or duplicate pieces of product information into the same category. Such categories of product information are then stored at database 212.

Subsequent to a deduplication process, a user (e.g., buyer) using client 204 may submit a search query for relevant product information at the website. A search engine associated with web server 208 may receive the search query and perform a search through the stored product information stored at database 212. In order to avoid presenting redundant search results, in some embodiments, just one piece of product information is selected from each matching category (and not multiple duplicate pieces from the same category) and is returned for the user at client 204.

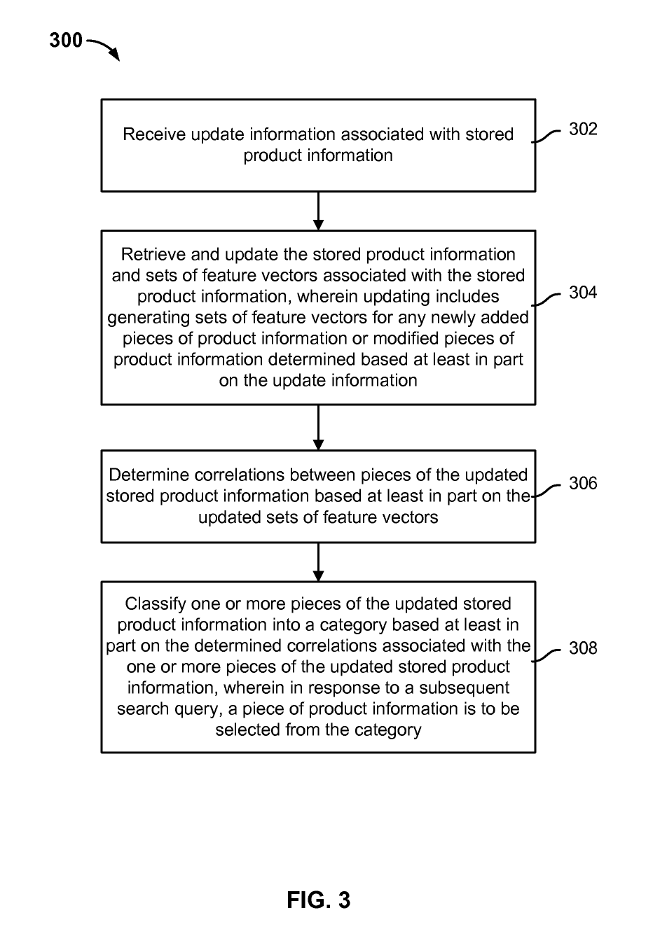

FIG. 3 is a flow diagram showing an embodiment of a process for performing deduplication of product information search results.

In process 300, a database may store existing pieces of product information. For example, the pieces of product information may have been submitted by seller users. In some embodiments, one or more corresponding feature vectors may have been determined and stored for each stored piece of product information. As will be described further with process 300, updates may be made to the stored product information (e.g., based on user submissions). For example, an update may include user submitted new pieces of product information being added to the stored product information, modifications to existing pieces of stored product information, and/or deletion of any existing pieces of stored product information. As will be described further below, deduplication is performed on the set of stored existing product information modified by an update (e.g., the addition of new piece(s) of product information, the modification of existing piece(s) of product information, or the deletion of existing piece(s)) each time an update occurs. That way, the stored product information may be deduplicated in a relatively real-time manner, because the stored product information is deduplicated in response to an update and the stored product information is deduplicated at almost every opportunity there is to potentially add redundant product information. This way, a search through the product information subsequent to an update and a deduplication will likely not return any duplicate pieces of product information. As such, process 300 may reduce redundant information within the search results, enable rapid transmission of search results from the server to the client, and increase the accuracy of search results.

At 302, update information associated with stored product information is received.

In various embodiments, existing product information associated with one or more websites is maintained at a database. For example, if the website were an e-commerce website, then the stored product information may include product information submitted by seller users of the website. For example, a piece of product information may include identifying information associated with the seller user that submitted that piece of product information, descriptions of a product, the price of the product, specifications of the product, an image of the product, the number of available units of the product, and so forth. For example, a webpage may be created at the e-commerce website for each product for sale by a particular seller user and product information associated with that product may be submitted by that seller user to be displayed at the webpage. In some embodiments, a piece of product information includes the product information to be displayed at a webpage associated with a particular product and a particular seller of that product. The stored product information is maintained so that for a user that potentially desires to purchase a product at the website, the user may submit a search query at the website and pieces of the stored product information that match the query will be returned as search results for the buyer user.

In various embodiments, an update may be made to the stored product information. For example, the update may be made by a seller user's selection to submit new piece(s) of product information, selection to modify existing piece(s) of product information, and/or selection to delete an existing piece(s) of product information. For example, at a webpage at the e-commerce website, a seller user may activate user interface widgets (e.g., selection button(s)) associated with submitting new product information, modifying existing product information, and/or deleting existing product information.

In some embodiments, the update information includes at least whether the update is associated with the submission of new product information, the modification of existing product information, and/or the deletion of existing product information. In some embodiments, the update information also includes at least the new piece(s) of product information to add, information identifying existing piece(s) of product information to modify and the associated modification(s), and/or information identifying existing piece(s) of product information to delete.

At 304, the stored product information and sets of feature vectors associated with the stored product information are retrieved and updated, wherein updating includes generating sets of feature vectors for any newly added pieces of product information or modified pieces of product information determined based at least in part on the update information.

In various embodiments, one or more feature vectors are generated for each stored piece of product information. A feature vector represents characteristics of a piece of product information and in various embodiments, a set of feature vectors of the piece of product information may be used to represent the piece of product information. In some embodiments, each set of feature vectors is stored with information identifying the piece of product information that it represents. For example, one or more feature vectors generated for a piece of product information may include: identification of the user that submitted the piece of product information, product titles, product attributes, product model, product manufacturer, product brand, and product keywords.

As will be discussed below, the similarity between a first piece of product information and a second piece of product information may be computed based on the set of feature vectors generated for the first piece of product information and the set of feature vectors generated for the second piece of product information. The similarity between two pieces of product information may indicate whether one is a duplicate of the other.

In various embodiments, the stored existing product information and stored sets of feature vectors generated for the existing product information are retrieved and updated based on the update information. In response to receiving the indication to update, it is determined whether the update is associated with an addition of new product information, the modification of existing product information, and/or the deletion of existing product information. Then the stored product information and its corresponding feature vector sets are updated as follows:

In the event that the update information identifies an existing piece of product information to be modified, that existing piece of product information is modified and a corresponding set of feature vectors is generated for (e.g., extracted from) the newly modified piece of product information. For example, let us assume that the update information instructs that product information A is to be modified and so any previous feature vectors determined for product information A is deleted and replaced with newly generated feature vectors A1, A2 and A3, where A1, A2, and A3 are generated based on the modified version of product information A. In the updating process, the corresponding relationships between product information A and the feature vector set including A1, A2, and A3 are stored. For example, the corresponding relationships may indicate that product information A is associated with the feature vectors A1, A2, and A3.

In the event that the update information identifies a new piece of product information to be added, the new piece of product information is added to the set of stored product information and a corresponding set of feature vectors is generated for (e.g., extracted from) the new piece of product information. For example, let us assume that the update information instructs that new product information B is to be added and so new feature vectors B1, B2 and B3 are generated for the new product information B. In the updating process, the corresponding relationships between product information B and the feature vector set including B1, B2 and B3 are stored. For example, the corresponding relationships may indicate that product information B is associated with the feature vectors B1, B2, and B3.

In the event that the update information identifies an existing piece of product information to be deleted, that existing piece of product information is deleted from the set of stored product information and its corresponding set of feature vectors is deleted as well. For example, let us assume that the update information instructs that existing product information C is to be deleted and that the update information has indicated that the feature vectors stored for the deleted product information C are C1, C2 and C3. In the updating process, the stored corresponding relationships between product information C and the feature vector set including C1, C2 and C3 are deleted. For example, corresponding relationships may indicate that product information C is associated with the feature vectors C1, C2, and C3.

In some embodiments, a set of feature vectors may be generated for a new piece of product information or modified piece of product information as follows: a user submitted update information to the stored product information is received. The submitted update information will then be checked. For example, the publication format of the product information or the access privileges of the user that submitted the update information may be checked against rules/stored security permissions. In the event that the update is approved, a message requesting generation of feature vectors for any new piece of product information and/or modified piece of product information is sent to a background server. The background server will generate a new set of feature vectors for each newly added piece of product information and a new set of feature vectors for each piece of modified product information.

In some embodiments, a parameter associated with batching feature vectors to be generated may be configured by a system administrator. In some embodiments, a maximum quantity may be preset such that new or modified pieces of product information that are introduced by updates may be batched up to the maximum quantity and then processed together to increase efficiency. For example, if the quantity of new or modified pieces of product information for which feature vectors are to be generated for an update exceeds the maximum quantity, then the feature vectors may be generated for a portion of such new or modified pieces of product information less than the maximum quantity. This way, the quantity of pieces of product information for which feature vectors are to be generated for each batch is controlled based on the established maximum quantity. Controlling the quantity of pieces of product information for which feature vectors are to be generated for each batch helps to keep the time of processing within a certain range. One or more batches of feature vectors may be generated for each update. Batching the generation of feature vectors may provide consistency and efficiency for this real-time technique of product information deduplication.

At 306, correlations between pieces of the updated stored product information are determined based at least in part on the updated sets of feature vectors.

In some embodiments, correlations are determined between every piece of updated product information (i.e., an existing piece of product information that has not been deleted, a newly added piece of product information, or a modified piece of product information) and every other piece of product information each time there is an update. In some embodiments, a correlation between two pieces of product information represents the degree of similarity between the two pieces of product information. For example, if two pieces of product information share a strong correlation, then the two pieces are very similar to each other. In some embodiments, a correlation is determined between two pieces of product information based on their corresponding sets of feature vectors.

In some embodiments, in a more incremental approach, correlations are determined between each piece of updated product information (i.e., either a newly added piece of product information or a modified piece of product information) and an existing piece of (not modified or deleted) product information each time there is an update.

For example, assume that a set of feature vectors B1, B2 and B3 is associated with newly added product information B and that set of feature vectors C1, C2 and C3 is associated with modified product information C. Also, assume that set of feature vectors A1, A2, and A3 is associated with existing (not newly added or modified or deleted) product information A. In computing correlations between existing product information and newly added or modified product information, the correlation between product information A and B and the correlation between product information A and C are computed using sets of feature vectors (A1, A2 and A3), (B1, B2 and B3), and (C1, C2 and C3). To take the correlation between product information A and B as an example, the correlation between A and B may be determined based on a combination of the similarity S1 between A1 and B1, the similarity S2 between A2 and B2, and the similarity S3 between A3 and B3. Various known techniques may be used to determine similarities between sets of feature vectors.

At 308, one or more of the pieces of the updated stored product information are classified into a category based at least in part on the determined correlations associated with the one or more pieces of the updated stored product information, wherein in response to a subsequent search query, a piece of product information is to be selected from the category.

In some embodiments, some of the stored existing product information may be classified into various categories (e.g., based on a previous determination), where each category includes one or more pieces of product information that are very similar to each other. In some embodiments, a similarity threshold may be preset such that pieces of product information whose correlations to each other are above the threshold amount may be classified into the same category. A category may include at least one piece of product information. Due to the strong similarity between pieces of product information within a category, the pieces of product information within each category are considered to be duplicates of each other.

In some embodiments, the newly added pieces of product information, if any, and the modified pieces of product information, if any, are sorted into categories that existing pieces of product information already belong to or into new categories. This way, the updated pieces of product information (the newly added pieces of product information and modified pieces of product information) may be quickly classified into categories of duplicate information.

By classifying similar pieces of product information together into a category, deduplication of product information within search results may be accomplished. In some embodiments, all the pieces of product information that are classified into the same category are considered duplicates of each other and are also labeled with identifying information (e.g., descriptive information associated with the category) of the category.

In various embodiments, deduplication of product information within search results includes finding one piece of product information from each category that matches a search query to be returned as a search result for that category. Because the pieces of product information within the same category are considered to be duplicates of each other, in some embodiments, selecting just one of the pieces of product information for each matching category to be presented as a search result (while the non-selected pieces of product information are not to be presented as a search result) reduces the amount of redundant information that will be presented for the searching user. In some embodiments, the piece of product information that is most similar (e.g., has the highest correlation or match to the search query) is selected from each category. For example, it may be first determined which categories each search query matches based on the identifying information associated with the category, and then the piece of product information from each matching category that is most similar to the search query is chosen to be presented among the search results. In another example, it may be first determined which pieces of product information from any category match the search query and then only the piece of product information from each category that is most similar to the search query is selected to be presented among the search results. By performing such deduplication of presented search results, fewer search results need to be found and transmitted from the server to be presented at the client, which increases efficiency.

In some embodiments, classifying product information into categories may include classifying pieces of product information into a category based on their corresponding correlations that are associated with the same seller user (the user that submitted the product information). This way, each category includes not only similar pieces of product information but also product information that is submitted by the same seller user. This may be able to avoid labeling as duplicates similar product information that is submitted by different users.

In some embodiments, a parameter associated with a time by which to determine search results may be configured by a system administrator. Sometimes, a search query may be received prior to the completion of a deduplication process. In order to better serve the searching user by presenting the search results in a relatively quick manner, a time period threshold value may be preset such that if the deduplication process does not complete within the threshold period of time, then search results are found among the not completely deduplicated product information based on the assumption that it would better serve searching users by returning search results faster with the possibility of returning redundant results rather than taking longer to return results with no redundant results.

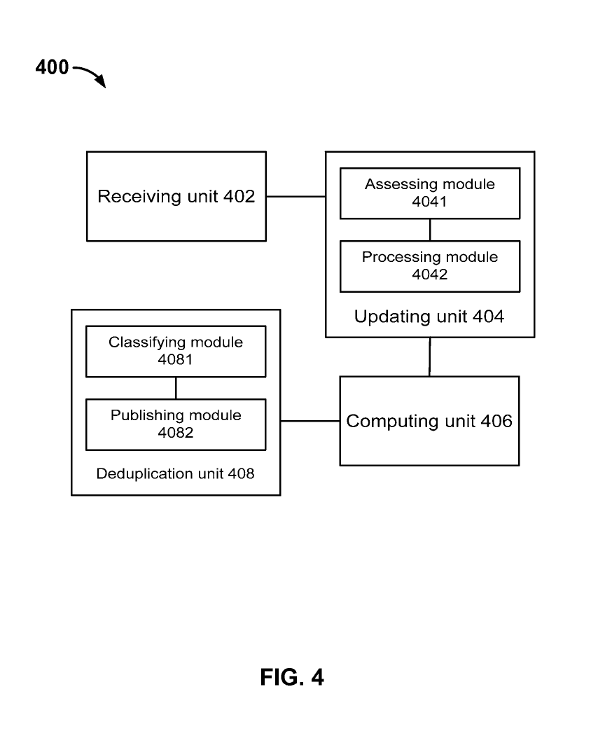

FIG. 4 is a diagram showing an embodiment of a system for performing deduplication on product information search results. In the example, system 400 includes receiving unit 402, updating unit 404, assessing module 4041, processing module 4042, computing unit 406, deduplication unit 408, classifying module 4081, and publishing module 4082.

The units and subunits can be implemented as software components executing on one or more processors, as hardware such as programmable logic devices and/or Application Specific Integrated Circuits designed to perform certain functions, or a combination thereof. In some embodiments, the units and subunits can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units and subunits may be implemented on a single device or distributed across multiple devices.

In some embodiments, receiving unit 402 is configured to receive product update information that was input by users. Updating unit 404 is configured to retrieve and update the stored product information and sets of feature vectors associated with the stored product information. Updating includes generating sets of feature vectors for any newly added pieces of product information or modified pieces of product information determined based at least in part on the update information. Computing unit 406 is configured to determine correlations between pieces of the updated stored product information based at least in part on the updated sets of feature vectors. Deduplication unit 408 is configured to classify one or more pieces of the updated stored product information into a category based at least in part on the determined correlations associated with the one or more pieces of the updated stored product information, wherein in response to a subsequent search query, one piece of product information is to be selected from the category.

In various embodiments, the feature vectors corresponding to stored product information are updated online to perform deduplication and in real time in response to received update information (e.g., instead of at every set period).

Updating unit 404 comprises: assessing module 4041 and processing module 4042. Assessing module 4041 is configured to assess whether the update information instructs that existing product information is to be modified or deleted or that new product information is to be added. A processing module 4042 is configured to, when the update information instructs that existing product information is to be modified, acquire the feature vectors for the modified product information from feature vector sets and update the feature vectors that correspond to the modified product information. A processing module 4042 is configured to, when the update information instructs that new product information is to be modified, generate feature vectors for the new product information and add the feature vectors for the new product information to the feature vector sets. A processing module 4042 is configured to, when the product update information instructs that existing product information is to be deleted, delete the feature vectors corresponding to the existing product information from the feature vector sets.

In some embodiments, receiving unit 402 receives user-submitted update information online, and then receiving unit 402 checks the update information. If receiving unit 402 approves of the update information, then receiving unit 402 sends a message requesting generation of feature vectors to updating unit 404. Updating unit 404 responds to the message requesting generation of feature vectors by computing the feature vectors for modified product information or the feature vectors for the new product information.

In some embodiments, processing module 4042 is also configured to update the feature vectors based on the update information instructions in batches if the quantity of feature vectors that are to be updated exceeds a maximum quantity, where the quantity of each batch of feature vectors to update does not exceed the maximum quantity.

Deduplication unit 408 includes classifying module 4081 and publishing module 4082. In some embodiments, classifying module 4081 is configured to determine category labels for pieces of product information that were determined to be included in the same category. Publishing module 4082 is configured to send the piece of product information in each category that is most similar to a submitted search query as part of search results to be displayed. In some embodiments, classifying module 4081 is configured to first classify product information based on the identity of the user that submitted the information.

In some embodiments, a preferred published module (not shown) is included in system 400 and is configured to determine whether the deduplication process has taken beyond a time period threshold value to complete and if so, then to use the product information on which deduplication has not been completed to determine search results for a received search query.

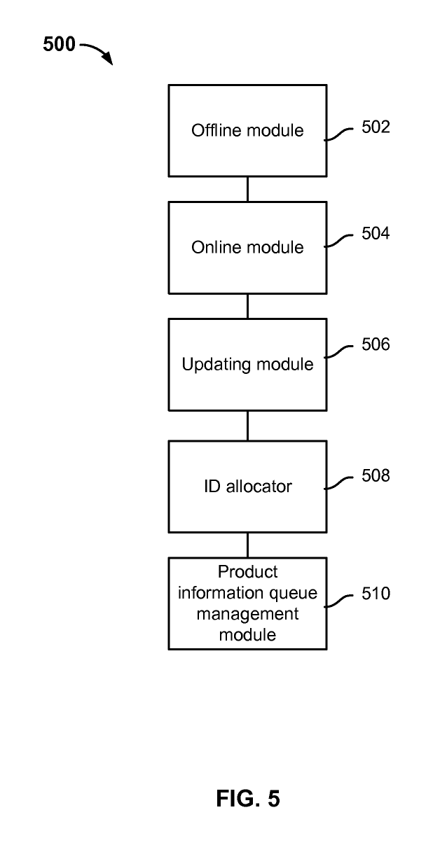

FIG. 5 is a diagram showing an embodiment of a system for performing deduplication on product information search results. In the example, system 500 includes offline module 502, online module 504, updating module 506, ID allocator module 508, and product information queue management module 510.

Offline module 502 is configured to aggregate all existing product information stored on one or more website servers, generate a master index file for the feature vectors corresponding to the stored product information, and determine identifying information (e.g., including a category ID) for each category to which each piece of product information is determined to belong. Offline module 502 is configured to save this information (including product information, the feature vectors for the product information, and the categories to which subsets of the product information belong) in a database. In some embodiments, offline module 502 is invoked just once before the system 500 is used.

Online module 504 is configured to receive transmitted product information. Online module 504 performs assessments using the master index and the incremental datasheet. Online module 504 may determine whether a received piece of product information is a duplicate (e.g., for being similar to another piece of product information) and the identifying information of the category to which it belongs. Moreover, online module 504 saves the feature vector information for this piece of product information in an incremental datasheet that is tracked for transmitted product information.

Updating module 506 is configured to update the master index with the incremental index. Updating module 506 uses information in the online product information database to filter out (e.g., deleted or invalid) information in the master index and the incremental datasheet. Moreover, updating module 506 is configured to merge the master index and the incremental datasheet to generate a new master index file. Updating module 506 also may invoke ID allocator 508 to recover all unused IDs that are not used by identifying information associated with existing categories.

ID allocator 508 is configured to allocate 32-digit IDs in cooperation with online module 504. ID allocator 508 is configured to assign a unique code for each determined product information category to be included in the identifying information associated with that category. In other words, multiple pieces of product information in the same category will have the same category ID.

Product information queue management module 510 is configured to receive product information sent from applications and perform queue management. Product information queue management module 510 uses online module 504 sequentially to perform assessments and sends back the results to ensure that online module 504 is not excessively busy.

In some embodiment, for deduplication on product information in real time, distributed offline computations on hundreds of millions of pieces of product information may be performed stored on website servers in the initialization process. The similarities between all pieces of product information are determined and the pieces of product information are determined based on their similarities, and this information (including product information, the feature vectors for the product information, and the categories to which the product information belongs) is stored in a database. Simultaneously, batches of pieces of product information published (posted) in real time by users are processed to determine incremental product information categorization information in real time. The database is then updated based on the incremental product information categorization information. In the search process, a user inputs query information into the search engine, and the search engine looks up in the database for one or more categories that match the query information. In the one or more matching categories that it finds, the product information from each category that has the highest similarity to the query information is found and displayed as search results. As a result, efficient deduplication of displayed search results is achieved and seller users are prevented from engaging in the fraudulent conduct of issuing duplicate products.

In some embodiments, the described deduplication technique may be performed at a search engine. For example, in response to receiving a search query, the search engine may rank product information within the same category based on their respective similarities to the search query and it may display that product information within a category which is most closely related to the query input by the user.

In some embodiments, the programming language of C++ may be used in developing the programs to determine duplicate pieces of product information and for the base layer of search engines. Category information calculations for all the product information at websites may require a distributed data pre-processing system environment to ensure computational efficiency. The database system (e.g., Oracle) may need to have quite powerful synchronization and trigger mechanisms so as to ensure the accuracy and consistency of data.

In some embodiments, the similarities between every existing piece of product information in real time and every incremental piece of product information are determined. The similarity determination (duplicates determination) of website product information is completed by using multi-dimensional vectors of structured data to compute relatedness. Examples of algorithms to use to determine similarities (determination of duplicates) include: Match, Shingliing, SimHash (locality sensitive hash), Random Projection, and SpotSig.

In some embodiments, after data (e.g., feature vectors for product information, etc.) is obtained from the database, exception processing capability may be used to ensure that data will not be erroneously removed. As such, once product information is classified into various categories, the piece of product information from each category that is most similar to a user submitted search query is returned to be presented within search results.

In addition, in providing technical solutions for real-time information deduplication, one should select index building technical frameworks in accordance with differences in real-time operating requirements. At the same time, one needs to consider having compensatory mechanisms in case real-time computations of similarities exceed desired time limits. Finally, deduplication of horizontal information (information sets with restrictive requirements) can be replaced with that of vertical information (information sets without restrictive requirements) in accordance with different business operating requirements.

Obviously, persons skilled in the art should understand that each module or step described above in the present application can be realized through general computing devices. They can be concentrated on a single device or distributed across a network composed of several computing devices. Optionally, they can be realized through executable program codes of computing devices, and thus they can be stored on storage devices and executed by computing devices. Moreover, in certain situations, the steps that are shown or described may be executed in sequences other than the ones here. Or they may be made separately into various integrated circuit modules, or their multiple modules or steps may be made into a single integrated circuit module. Thus, the present application is not limited to any specific combination of hardware and software.

The above are merely the preferred embodiments of the present application and are not for limiting the present application. For persons skilled in the art, the present application could have various modifications and changes. Any modification, equivalent substitution, or improvement made within the spirit and principles of the present application shall be contained within the protective scope of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for performing deduplication on product information search results, comprising:
one or more processors configured to:
receive update information associated with stored product information;
retrieve and update the stored product information and sets of feature vectors associated with the stored product information, wherein updating includes generating sets of feature vectors for any newly added pieces of product information or modified pieces of product information determined based at least in part on the update information;
determine correlations between pieces of the updated stored product information based at least in part on the updated sets of feature vectors; and
classify one or more pieces of the updated stored product information into a category based at least in part on the determined correlations associated with the one or more pieces of the updated stored product information, wherein in response to a subsequent search is query, a piece of product information is to be selected from the category; and
one or more memories coupled to the one or more processors and configured to provide the one or more processors with instructions.

2. The system of claim 1, wherein the update information indicates one or more of the following: information identifying a new piece of product information to be added, information identifying a first existing piece of product information to be modified, and information identifying a second existing piece of product information to be deleted.

3. The system of claim 1, wherein prior to retrieving and updating the stored product information and the sets of feature vectors associated with the stored product information, checking and approving the update information.

4. The system of claim 1, wherein retrieving and updating the stored product information includes one or more of the following: adding a new piece of product information, modifying a first existing piece of product information, and deleting a second existing piece of product information.

5. The system of claim 1, wherein generating sets of feature vectors for any newly added pieces of product information or modified pieces of product information determined based at least in part on the update information includes:
determining whether a quantity associated with the newly added pieces of product information or modified pieces of product information exceeds a maximum quantity; and
in the event that the maximum quantity is exceeded, generating sets of feature vectors for a batch including fewer than the maximum quantity of the newly added pieces of product information or modified pieces of product information.

6. The system of claim 1, wherein a correlation between a first piece of updated stored to product information and a second piece of updated stored product information indicates a degree of similarity between the first and second pieces of updated stored product information.

7. The system of claim 1, wherein the one or more pieces of the updated stored product information that are classified into the category are stored with identifying information associated with the category.

8. The system of claim 1, wherein the piece of product information selected from the category is to be presented as a search result with one or more other search results.

9. A method for performing deduplication on product information search results, comprising:
receiving update information associated with stored product information;
retrieving and updating the stored product information and sets of feature vectors associated with the stored product information, wherein updating includes generating sets of feature vectors for any newly added pieces of product information or modified pieces of product information determined based at least in part on the update information;
determining correlations between pieces of the updated stored product information based at least in part on the updated sets of feature vectors; and
classifying one or more pieces of the updated stored product information into a category based at least in part on the determined correlations associated with the one or more pieces of the updated stored product information, wherein in response to a subsequent search query, a piece of product information is to be selected from the category.

10. The method of claim 9, wherein the update information indicates one or more of the following: information identifying a new piece of product information to be added, information identifying a first existing piece of product information to be modified, and information identifying a second existing piece of product information to be deleted.

11. The method of claim 9, wherein prior to retrieving and updating the stored product information and the sets of feature vectors associated with the stored product information, checking and approving the update information.

12. The method of claim 9, wherein retrieving and updating the stored product information includes one or more of the following: adding a new piece of product information, modifying a first existing piece of product information, and deleting a second existing piece of product information.

13. The method of claim 9, wherein generating sets of feature vectors for any newly added pieces of product information or modified pieces of product information determined based at least in part on the update information includes:
determining whether a quantity associated with the newly added pieces of product information or modified pieces of product information exceeds a maximum quantity; and
in the event that the maximum quantity is exceeded, generating sets of feature vectors for a batch including fewer than the maximum quantity of the newly added pieces of product information or modified pieces of product information.

14. The method of claim 9, wherein a correlation between a first piece of updated stored product information and a second piece of updated stored product information indicates a degree of similarity between the first and second pieces of updated stored product information.

15. The method of claim 9, wherein the one or more pieces of the updated stored product information that are classified into the category are stored with identifying information associated with the category.

16. The method of claim 9, wherein the piece of product information selected from the category is to be presented as a search result with one or more other search results.

17. A computer program product for performing deduplication on product information search results, wherein the computer program product being embodied in a computer readable storage medium and comprising computer instructions for:
receiving update information associated with stored product information;
retrieving and updating the stored product information and sets of feature vectors associated with the stored product information, wherein updating includes generating sets of feature vectors for any newly added pieces of product information or modified pieces of product information determined based at least in part on the update information;
determining correlations between pieces of the updated stored product information based at least in part on the updated sets of feature vectors; and
classifying one or more pieces of the updated stored product information into a category based at least in part on the determined correlations associated with the one or more pieces of the updated stored product information, wherein in response to a subsequent search query, a piece of product information is to be selected from the category.
